(19) United States
(12) Patent Application Publication
(10) Pub. No.: US 2010/0128300 A1
(43) Pub. Date: May 27, 2010

(54) MOBILE OFFICE SOLUTION

(75) Inventor: Brandon Paul Freeman, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: COMMNEXUS SAN DIEGO, San Diego, CA (US)

(21) Appl. No.: 12/276,204

(22) Filed: Nov. 21, 2008

(51) Int. Cl. G06F 3/12

(52) U.S. Cl. 358/1.15

(57) ABSTRACT

A mobile information technology infrastructure system, including: a server; a broadband network aggregator coupled to the server; at least one wireless communication device coupled to the broadband network aggregator; and a mobile enclosure configured to include the server, the broadband network aggregator, and at least one wireless communication device, wherein the server, the broadband network aggregator, and at least one wireless communication device are aggregated to combine the bandwidth of at least one wireless communication device and to generate information technology services with a single wireless backhaul channel.

### BACKGROUND

1. Field of the Invention

The present invention relates to information technology infrastructure, and more specifically, to providing mobility to such an infrastructure.

2. Background

The conventional information technology infrastructure can be complex and expensive. Further, it may be difficult, in certain situations, to receive sufficient and appropriate information technology services. Accordingly, there is a need for providing information technology infrastructure solution.

### SUMMARY

The present invention provides for mobile information technology infrastructure, where a server, a broadband network aggregator, and at least one wireless communication device are aggregated to combine the bandwidth of at least one wireless communication device and to generate information technology services with a single wireless backhaul channel.

In one implementation, a mobile information technology infrastructure system is disclosed. The system including: a server; a broadband network aggregator coupled to the server; at least one wireless communication device coupled to the broadband network aggregator; and a mobile enclosure configured to include the server, the broadband network aggregator, and at least one wireless communication device, wherein the server, the broadband network aggregator, and at least one wireless communication device are aggregated to combine the bandwidth of at least one wireless communication device and to generate information technology services with a single wireless backhaul channel.

In another implementation, a method of providing information technology infrastructure solution is disclosed. The method including: placing and aggregating a server, a broadband network aggregator, and at least one wireless communication device in a mobile enclosure; combining the bandwidth of at least one wireless communication device; and generating information technology services with a single wireless backhaul channel.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a block diagram of a mobile information technology infrastructure system in accordance with one implementation of the present invention.

FIG. 2 is a flowchart showing a method of providing information technology infrastructure solution in accordance with one implementation of the present invention.

### DETAILED DESCRIPTION

Certain implementations as disclosed herein provide for mobile information technology infrastructure, where a server, a broadband network aggregator, and at least one wireless communication device are aggregated to combine the bandwidth of at least one wireless communication device and to generate information technology services with a single wireless backhaul channel. After reading this description it will become apparent how to implement the invention in various alternative implementations and alternative applications. However, although various implementations of the present invention will be described herein, it is understood that these implementations are presented by way of example only, and not limitation. As such, this detailed description of various alternative implementations should not be construed to limit the scope or breadth of the present invention.

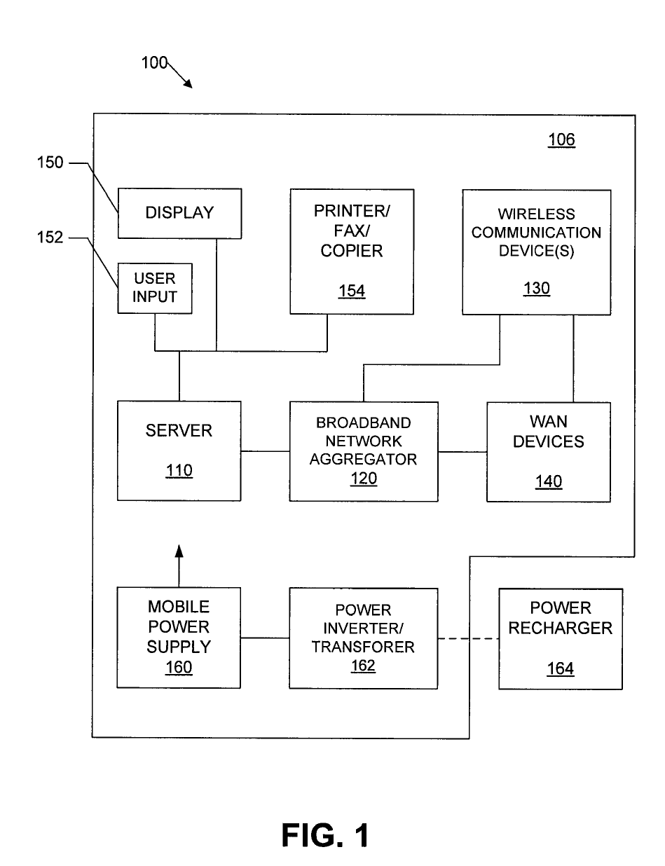

FIG. 1 is a block diagram of a mobile information technology infrastructure system 100 in accordance with one implementation of the present invention. In the illustrated implementation, the mobile information technology infrastructure system 100 includes a server 110, a broadband network aggregator 120, at least one wireless communication device 130, and wide-area network (WAN) devices 140, provided in a mobile enclosure 106. The mobile enclosure 100 also includes a display 150, a user input device 152, an output device 154, a mobile power supply 160, and a power transformer 162. The output device 154 includes at least one of a printer, a FAX device, and a copier. Further, the mobile power supply 160 can be recharged using a power re-charger 164. Accordingly, a plurality of apparatus or devices 106, 110, 120, 130, 140, 150, 152, 154, 160, 162, 164 in the mobile information technology infrastructure system 100 are configured to provide office information technology services including computing, storage, Internet, email, and scan/copy/fax/printing services on a platform that is wireless and cordless to be deployed anywhere.

In one implementation, the rechargeable mobile power supply 160 in the mobile information technology infrastructure system 100 allows the system to operate for is a fixed amount of time without the need for recharging from a stationary power source. The power source can then be recharged by various means including plugging the system into a standard wall outlet.

In the illustrated implementation of FIG. 1, the 20 mobile information technology infrastructure system 100 allows aggregation of various wireless communications technologies devices (e.g., Evolution Data Only (EV-DO) which is a standard for high speed wireless broadband; Satellite; and Wi-Fi) to combine the bandwidth of the devices and to generate information technology services with a single wireless backhaul channel. The scalability of the combined bandwidth is sufficient to support local area network and/or wide area network (LAN/WAN) structures (including workstations, smart phones, servers, and the like), and to operate effectively to provide a mobile office information technology environment. In a further implementation, a plurality of information technology infrastructure systems (similar to the system 100) are wirelessly daisy-chained together to scale up to a required size, which can support enterprise operations from one to several thousand users at a time.

The mobility of the mobile information technology infrastructure system 100 allows the devices to be transported, operated, and repaired easily. The mobility further allows the system 100 to be repositioned without reprogramming or maintenance of the devices. The mobile enclosure 106 can be transported and deployed anywhere there is appropriate telecommunication carrier coverage available. Therefore, the mobile information technology infrastructure system 100 can be deployed by specific verticals that rely on mobility or deployment in areas where traditional infrastructure is either not present or unavailable. These areas include: Military Operations; Homeland Security/Disaster Response; Construction; Work Sites in the Field; Consulting Firms; High Security Areas where clearance to use existing infrastructure is not permitted.

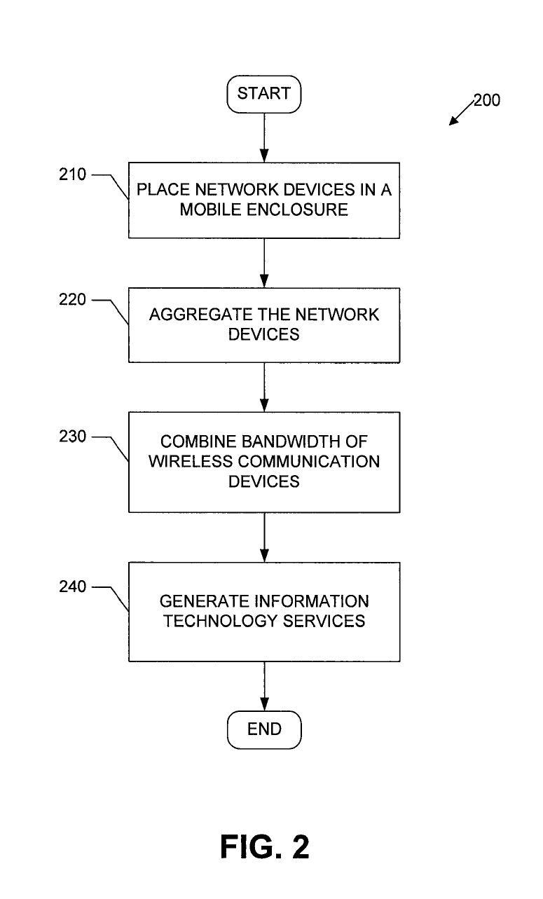

FIG. 2 is a flowchart 200 showing a method of providing information technology infrastructure solution in accordance with one implementation of the present invention. At 210, network devices such as server, broadband network aggregator, and at least one wireless communication device are placed in a mobile enclosure. The network devices are then aggregated, at 220, and the bandwidth of the wireless communication devices are combined, at 230. Accordingly, information technology services are generated, at 240, with a single wireless backhaul channel.

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Thus, it is to be understood that the description and drawings presented herein represent a presently preferred implementation of the invention and are therefore representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A mobile information technology infrastructure system, comprising:
a server;
a broadband network aggregator coupled to said server;
at least one wireless communication device coupled to said broadband network aggregator; and
a mobile enclosure configured to include said server, said broadband network aggregator, and said at least one wireless communication device,
wherein said server, said broadband network aggregator, and said at least one wireless communication device are aggregated to combine the bandwidth of said at least one wireless communication device and to generate information technology services with a single wireless backhaul channel.

2. The system of claim 1, wherein the information technology services comprises
at least one of computing, storage, Internet, e-mail, scan, copy, fax, and printing services.

3. The system of claim 1, further comprising
a plurality of wide area network devices coupled to said broadband network aggregator.

4. The system of claim 1, further comprising:
a display;
a user input device; and
an output device,
wherein said display, said user input device, and said output device are coupled to said server to provide scan, copy, fax, and printing services.

6. The system of claim 5, wherein said output device comprises
at least one of a printer, a FAX device, and a copier.

7. The system of claim 1, further comprising
a mobile power supply configured to provide power to said server, said broadband network aggregator, and said at least one wireless communication device in said mobile enclosure,
wherein said mobile power supply can be recharged.

8. The system of claim 1, wherein said at least one wireless communication device comprises
at least one of an EV-DO communication device, a satellite communication device, and a Wi-Fi communication device.

9. A method of providing information technology infrastructure solution, the method comprising:
placing and aggregating a server, a broadband network aggregator, and at least one wireless communication device in a mobile enclosure;
combining the bandwidth of the at least one wireless communication device; and
generating information technology services with a single wireless backhaul channel.

10. The method of claim 9, wherein generating information technology services comprises
providing at least one of computing, storage, Internet, e-mail, scan, copy, fax, and printing services.

11. The method of claim 9, further comprising
providing rechargeable power to the server, the broadband network aggregator, and the at least one wireless communication device in the mobile enclosure.

12. The method of claim 9, further comprising
wirelessly daisy-chaining together devices of the information technology infrastructure solution to increase bandwidth and scale up to a required size.

13. The method of claim 9, further comprising
transporting and deploying the information technology infrastructure solution.
